(19) United States
(12) Patent Application Publication
(10) Pub. No.: US 2004/0171320 A1
(43) Pub. Date: Sep. 2, 2004

(54) Fabric pads with a printed design and a method of making fabric pads with a printed design

(76) Inventors: Dean R. Shacklett, Blue Bell, PA (US); Neil G. Sellars, Cinnaminson, NJ (US); Richard Snyder, Gilbertsville, PA (US); David Wallace, Audubon, PA (US); James Mundy, Douglassville, PA (US); Gabriel Imhof, Berwyn, PA (US)

Correspondence Address: REED SMITH LLP, 2500 ONE LIBERTY PLACE, 1650 MARKET STREET, PHILADELPHIA, PA, 19103, US

(21) Appl. No.: 10/662,014

(22) Filed: Sep. 12, 2003

Related U.S. Application Data
(63) Continuation of application No. 09/349,737, filed on Jul. 8, 1999.

(51) Int. Cl. B32B 3/00; B32B 5/02

(52) U.S. Cl. 442/59; 442/327

(57) ABSTRACT

The present invention is directed to a pad for carrying liquid having a piece of non-woven material wherein the piece of material is capable of absorbing an amount of the liquid at least about 1.5 times the weight of the piece of material, a first printed ink on a first surface of the material, and a second printed ink on either the first or a second surface of the material, and wherein the first ink is substantially in register with the second ink. The present invention is also directed to a method for making a printed pad for carrying a liquid including the steps of feeding a web of non-woven material into a rotogravure press, wherein the material is capable of absorbing at least about 1.5 times its own weight of the liquid, printing a first ink with the press on a first surface of the web, printing a second ink with the press substantially in register-with the first ink on the first surface or a second surface of the web. The present invention is also directed to a system for cutting printed designs from a web of elastic material to form printed pads wherein the printed designs are printed on the web at a, repeat length having: a braked unwind station having a variable braking tension; an infeed station having an adjustable speed; a diecutter having a diecutting cylinder and a cylinder correction gearbox capable of correcting the position of the diecutting cylinder in a positive or negative rotational direction, wherein the circumference of the diecutting cylinder is greater than the repeat length; a first sensor for sensing the position of the printed designs on the web; a second sensor for sensing the position of the diecutting cylinder; a processor electronically coupled to the first sensor, the second sensor, the infeed station and the diecutter for controlling the infeed station and the diecutter in response to signals received from the sensors, wherein the processor sends a correction signal to the diecutting cylinder in response to signals from the sensors, the processor comprises a first counter for counting the number of consecutive corrections of the diecutting cylinder in the same direction and sending a correction signal to the infeed station when a predetermined number of consecutive corrections of the diecutting cylinder is reached.

### BACKGROUND OF THE INVENTION

1. Field of the Invention

The present invention is directed generally to fabric pads for the application of liquid products and a method for producing fabric pads, and, more particularly, to fabric pads with a printed design thereon and a method of making fabric pads with a printed design thereon.

2. Background

Fabric pads are commonly used as carriers and applicators for various liquid products, especially cleaning products, therapeutic products, dermatological products and the like. Such pads are typically packaged in containers with the liquid product, such that the pads absorb the liquid product. A user opens the container and removes one or more of the pads and applies the liquid product using the pads. Typically, product labeling, branding, design, or other trade dress features for such products are placed on the container containing the pads. The pads themselves generally carry no identifying indicia or design elements. The pads themselves infrequently display printed matter due to the substantial technical difficulty in printing on and otherwise processing such materials, particularly the low elastic deformation threshold of such materials. These difficulties are particularly acute in situations where it is desirable to print and maintain specific shapes on the pad, and in situations where printing is desired on both surfaces of the pads in substantial registration. In addition, where the products are intended for dermatological or other medical uses, any inks, including the vehicles and pigments must be approved by any relevant regulatory agencies, which substantially limits the types of inks that can be used. Finally, in any such application, it is important that there be little or no leaching of the inks into the product solution.

Therefore, the need exists for non-leaching printed pads which may be printed on both sides in register, and methods for making such pads.

### SUMMARY OF THE INVENTION

The present invention is directed to a pad for carrying liquid comprising a piece of non-woven material wherein the piece of material is capable of absorbing an amount of the liquid at least about 1.5 times the weight of the piece of material, a first printed ink on a first surface of the material, and a second printed ink on either the first or a second surface of the material, and wherein the first ink is substantially in register with the second ink.

The present invention is also directed to a method for making a printed pad for carrying a liquid comprising the steps of feeding a web of non-woven material into a rotogravure press, wherein the material is capable of absorbing at least about 1.5 times its own weight of the liquid, printing a first ink with the press on a first surface of the web, printing a second ink with the press substantially in register with the first ink on the first surface or a second surface of the web.

The present invention is also directed to a system for cutting printed designs from a web of elastic material to form printed pads wherein the printed designs are printed on the web at a repeat length having a braked unwind station having a variable braking tension, an infeed station having an adjustable speed, a diecutter having a diecutting cylinder and a cylinder correction gearbox capable of correcting the position of the diecutting cylinder in a positive or negative rotational direction, wherein the circumference of the diecutting cylinder is greater than the repeat length, a first sensor for sensing the position of the printed designs on the web, a second sensor for sensing the position of the diecutting cylinder, a processor electronically coupled to the first sensor, the second sensor, the infeed station and the diecutter for controlling the infeed station and the diecutter in response to signals received from the sensors, wherein the processor sends a correction signal to the diecutting cylinder in response to signals from the sensors, the processor comprises a first counter for counting the number of consecutive corrections of the diecutting cylinder in the same direction and sending a correction signal to the infeed station when a predetermined number of consecutive corrections of the diecutting cylinder is reached.

In short, the invention is directed to a printed pad made from an absorbent material, wherein the pad comprises a printed design comprising at least two inks printed in substantial register. The inks may be printed on the same or on opposite surfaces of the material. The pads may be diecut into any desired shape also in register with the printed design(s). In addition, the invention is directed to a method for making said printed pads. Because the pad material typically has a low threshold of plastic deformation, it is difficult to produce pads having inks printed in register, particularly on both surfaces of the material. For this reason as well, it is also difficult to produce pads having a consistent size and shape. The methods of the present invention overcome these and other difficulties.

### BRIEF DESCRIPTION OF THE DRAWINGS

Other objects, features and advantages of the present invention will become more fully apparent from the following detailed description of the preferred embodiments, the appended claims and the accompanying drawings in which:

FIG. 1 is a perspective view of a printed pad in accordance with the present invention;

FIG. 2 is a top view of a portion of web of material from which the printed pads of the present invention are formed;

FIG. 3 is a schematic view of a print system for printing a pad in accordance with the present invention;

FIG. 4 is a schematic top view of a system for cutting and stacking printed pads in accordance with the present invention;

FIG. 5 is a schematic representation of a rotogravure print cylinder for use in a system in accordance with the present invention; and

FIG. 6 is a schematic side view of the system of FIG. 4.

### DETAILED DESCRIPTION OF THE INVENTION

### Printed Pads

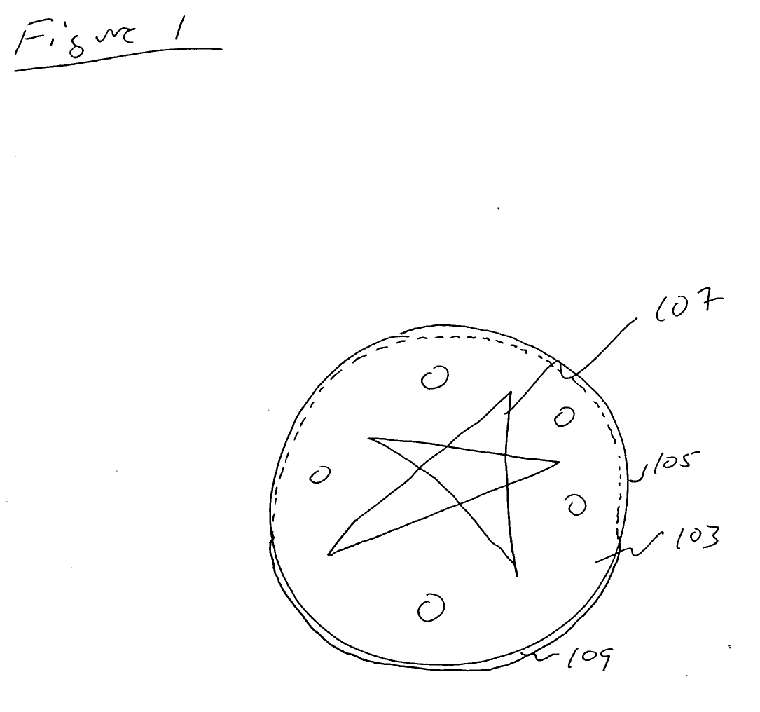

The present invention is directed to a printed pad 100 as shown in FIG. 1. The printed pad 100 comprises the pad material 101 having a top surface 103, a bottom surface 105, a thickness 109, and a design 107 comprising one or more inks. Optionally an identical design 107 may be printed on both surfaces 103 and 105 of the pad 101 and further may be printed in substantial registration on both sides 103 and 105. In a preferred embodiment, the pad 100 resembles a cross-section of material, such as a slice of cucumber. The materials and inks employed to make the printed pads 100 will be described in further detail below in describing the systems and methods for making the printed pads 100.

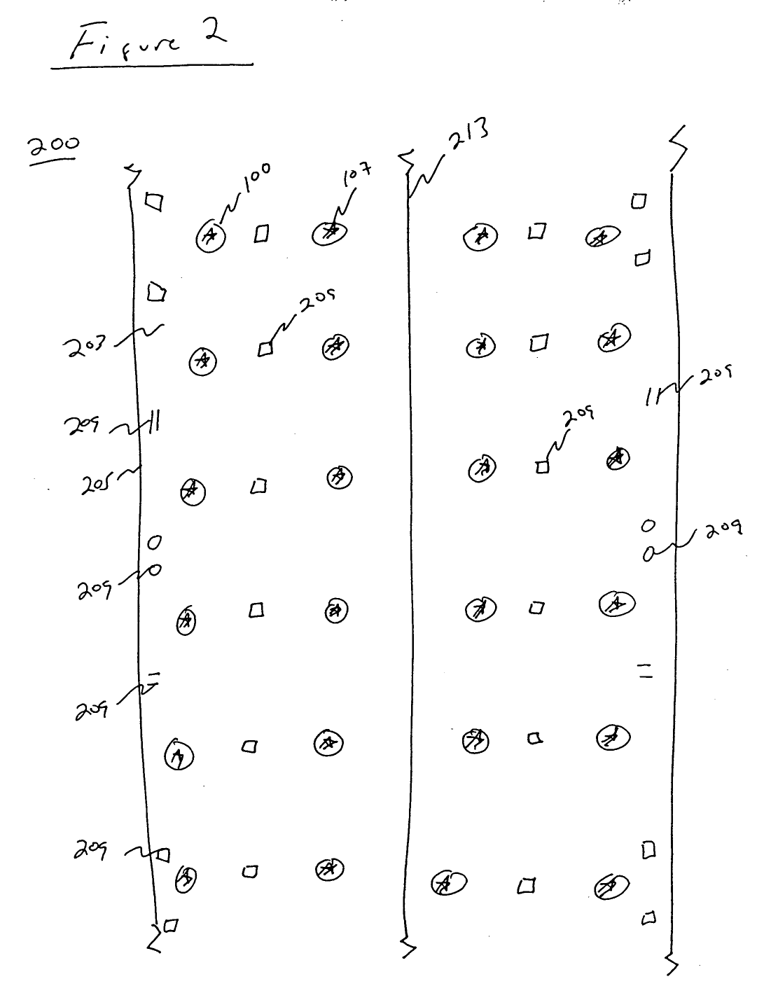

Referring now to FIG. 2 there is shown a portion of a web 200 of the material 101 from which the printed pads 100 of the present invention may be formed. The web 200 has a top surface 203, a bottom surface 205 and a thickness 109. The material 101 selected for the web 200 may vary depending upon the intended use of the liquid products. There are at least two sets of criteria employed in selecting a suitable web material 101. The first set of criteria includes functional properties relating to the web material's 101 suitability for its intended use, including, for example, the ability to absorb liquid, texture, feel and appearance. The second set of criteria includes functional properties relating the suitability of the web material 101 for printing, including, for example, density, transference (that is, the capacity for ink to be transferred to it from the printer), tensile strength, and overall printability. In the preferred embodiment of the present invention, the thickness 109 of web material is in the range between 30 and 50 mils.

In a preferred embodiment of the present invention, the web material 101 is a non-woven polyester with a minimum density of about 2.5 oz./yd² and a minimum tensile strength of about 30 lbs./in. Preferably, the web 200 is of a type equivalent to or substantially similar to SONTARA fabric type number S-8100 4.05 oz/yd² made by DuPont Inc. Other suitable fabrics include, without limitation: 100% non-woven polyesters MIRATEC #2554, #2556, #2557 available from PGI Nonwovens; Product no. A0168/23102 (a 45% polyester/55% cellulose blend) available from Dexter Corporation; VERATEK #1240.2, #149-616, #140,235 and Reemay #2024, #2033, #2295 available from BBA Non-Wovens Bethune; and #S-8007 available from DuPont.

The designs 107 are formed on the pads 100 with specific inks. One of the principal difficulties solved by the present invention is finding inks that meet certain criteria including, without limitation, the safety and other criteria set forth herein, and that also are effective to print on the preferred web materials. The inks used in the present invention are in liquid form. Preferably such inks contain no carbon. The inks are preferably solvent based gravure inks. The inks preferably have a viscosity of about 17 to 30 seconds in a #2 zahn.

The inks generally comprise two components, the vehicle and the pigment. Suitable vehicle systems include, nitrocellulose, polyamid, vinyl, acrylic, shellac and combinations thereof. Where the pads 100 are intended for dermatological use, as in a preferred embodiment of the present invention, the pigments are preferably approved or allowable by the relevant regulatory agencies and/or statutory or regulatory provisions, including, without limitation the U.S. Food and Drug Administration, California Proposition 65, CONEG compliance. Suitable preferred pigments include, without limitation, pigment blue 15-3, pigment yellow 42 and pigment green 18.

Preferably the inks undergo no visible leaching from the printed pads 100 when placed in contact with the solution used in the final product. Leaching may be evaluated in accordance with the following test:

1. A 10 count of printed pads is placed in a standard packaging jar with cap.

2. 20 g, of 10% ethanol (2 g per printed pad) is added to the jar.

3. The jar is sealed and placed in an electrical natural convection oven at 50° C. for 24 hours.

4. After 24 hours the jar is removed from the oven and allowed to cool to room temperature (approximately 3 hours).

5. Once cool 2-3 pads are removed from the jar and wrung out into a small clear vial.

6. The vial is examined visually against a white background to detect any visible leached ink. In a preferred embodiment, the ink must experience no visible leaching when subjected to the foregoing test.

Preferred inks may include the following inks supplied by Colorcon: FGN-2984 clear, FGN-4984 yellow, and FGN-3560 blue. These inks may be mixed to form various inks having desired colors. Preferred ink mixtures comprise about 50% to 80% FGN-2984 clear, about 20% to 50% FGN-4984 yellow, and about 2% to 10% FGN-3560 blue. An alternative preferred ink mixture comprises about 0% to 30% FGN-2984 clear, about 0% to 30% FGN-4984 yellow, and about 70%-100% FGN-5078 green. The blended inks are then reduced with acetate and alcohol to the desired viscosity.

### Printing System

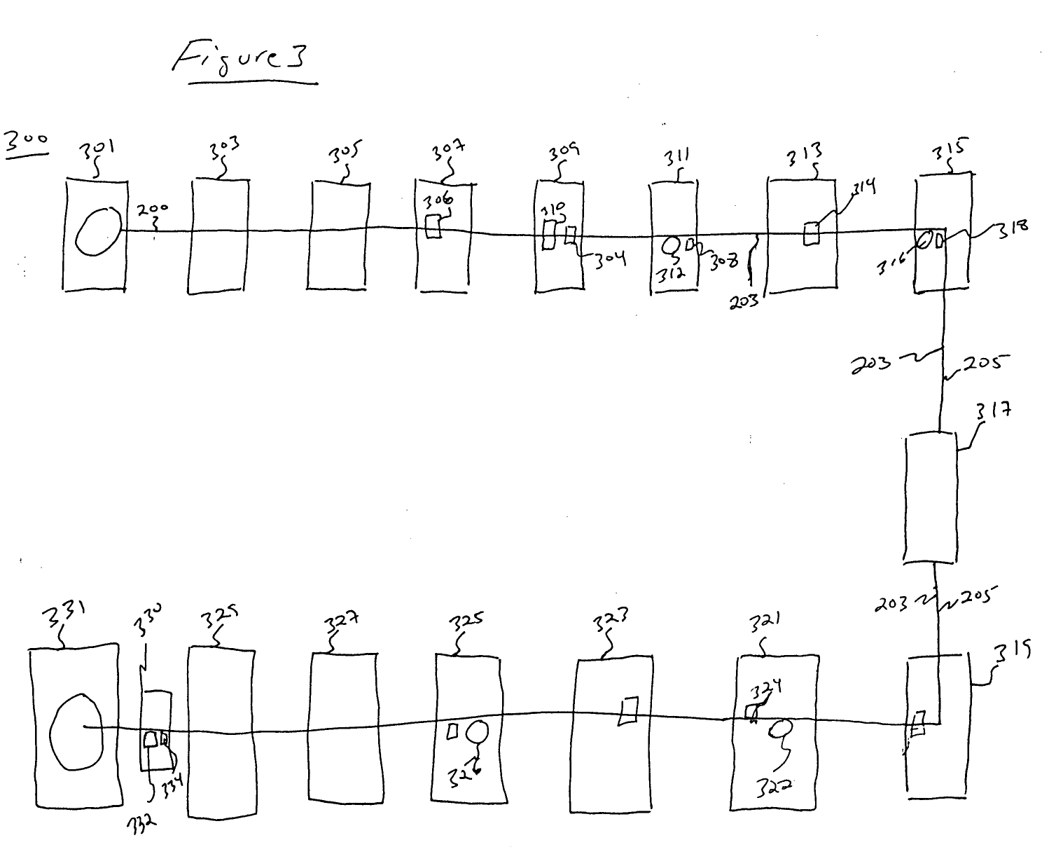

Referring now to FIG. 3, there is shown a schematic view of a system for making a printed a pad 100 in accordance with the present invention. The print system preferably comprises a printer or press 300 specifically adapted for printing on the web 200 of material 101.

The printer 300 is preferably a rotogravure press although any printing means capable of printing the inks on the material may be used, including without limitation flexography and flat bed gravure printing. The rotogravure press 300 comprises a plurality of stations through which the web 200 passes. Station 301 is an unwind station where a preferably blank web of material is unwound from a roll or spool.

Station 303 is an automatic splicer which splices the end of a first roll of web material to the end of second roll of web material such that a continuous web may be passed through the press 300 without interruption. With certain materials, such as the DuPont SONTARA fabric, it may be necessary to disable the automatic splicer.

Station 305 comprises festoons which provide a length of web material that may be advanced into subsequent stations of the press if the unwind system is temporarily delayed or slowed by, for example, an automatic splicing operation. The festoons 305 comprises a plurality of adjustably spaced apart rollers. The position of the rollers and, accordingly the tension on the web 200 in the festoons 305, is controlled by pneumatic pressure. In accordance with the present invention, it is preferable to set the festoons 305 with a just enough tension on the web 200 prevent the web 200 from binding in the press 300 from excess slack. In accordance with a preferred embodiment of the present invention, the festoons 305 may be set at about 3 bar.

Station 307 is an infeed station. The infeed station 307 comprises a nip roller or other device for controlling the rate at which the web 200 is fed into the press 300. In a preferred embodiment, the web 200 is run through the press 300 at about 105 to 115 feet per minute. The infeed station 307 also comprises means 306 for controlling the tension on the web 200. In a preferred embodiment, the infeed station 307 comprises a potentiometer and a roller on a dancer to measure and control the tension on the web. The tension on the web at the infeed station is preferably about 12 lbs.

Station 309 is a first print control station. Station 309 comprises a moveable roller 310 adapted to make fine adjustments to the longitudinal position of the web 200 in the first print station 311. First print station 311 comprises a print cylinder 312 that prints a first ink on the web 200. If it is desired to print the first ink on a specific longitudinal position on the web 200, for example, relative to a preexisting mark on the web 200, first print station 311 may also comprise a first web position sensor 308, such as an optical scanner. At the first print station 311, the first web position sensor 308 may compare the position of the first printed ink to a pre-existing mark on the web 200. If the first ink is not printed in the desired position relative to the pre-existing mark, the first control station 309 adjusts the longitudinal position of the web 200 such that subsequent applications of the first ink by the print cylinder 312 in the first print station 311 are in the desired position. The first web position sensor 308 may continually sense the longitudinal position of the web 200 and the first control station 309 may continually adjust the longitudinal position of the web 200 in response to the signal from the first web position sensor 308. In a preferred embodiment of the present invention, the web 200 is blank and there is no preexisting mark. As a result, in such an embodiment, there is no web position sensor 308 in the first print station 311 and there is no need for adjustment by the first control station 309. The first control station 309 may also comprise a potentiometer 304 which senses the tension on the web 200. The tension on the web 200 at the first control station 309 is preferably about 15 lbs.

The first print station 311, prints the first ink of the desired design on the top surface 203 of the web 200. The first print station 311 also preferably prints a first web position reference mark 209, (FIG. 2) on the top surface 203 of the web 200.

Station 313 is a second print control station. Station 313 is identical to station 309. Station 315 is a second print station that preferably applies a second ink with a second print cylinder 316. Station 315 preferably comprises a second web position sensor 318. The second web position sensor 318 senses the position of the first reference mark 209. Because of the nature of the web material, in a preferred embodiment, the second web position sensor 318 senses the longitudinal position (relative to the web) of the first reference mark 209 and does not sense the lateral position of the web 200. The lateral position of the web 200 may be observed and controlled manually. If the second ink is not printed in the desired longitudinal position relative to the first reference mark 209 and, therefore, the first ink, the second control station 313 adjusts the longitudinal position of the web 200 such that subsequent applications of the second ink by the print cylinder 316 in the second print station 315 are in the desired position. The second web position sensor 318 may continually sense the position of the web 200 and the second control station 313 may continually adjust the longitudinal position of the web 200 in response to the signal from the second web position sensor 318. The second control station 313 may also comprise a potentiometer 314 which senses the tension on the web 200. The tension on the web 200 at the second control station 313 is preferably about 10-14 lbs. The second print station 315, prints the second ink of the desired design on the front surface 203 of the web 200. The second print station 315 also preferably prints a second reference mark 211, on the front surface 203 of the web 200.

Station 317 comprises a turn-bar that positions the web 200 for printing on the second surface 205 of the web 200 in subsequent print stations.

Station 319 is a third print control station. Station 321 is a third print station. Stations 319 and 321 may be essentially identical to stations 313 and 315. The web position sensor 324 in print station 321 is positioned to read either the first or the second reference mark, which is printed on the front surface 203 of the web 200. The tension on the web 200 at the third control station 319 is preferably about 10-14 lbs.

The third print station 321, prints the third ink of the desired design on the bottom surface 205 of the web 200. The third print station 321 also preferably prints a third reference mark on the second side bottom surface 205 of the web 200.

Station 323 is a fourth print control station. Station 325 is a fourth print station. Stations 323 and 325 may be essentially identical to stations 313 and 315. The web position sensor in print station 325 is positioned to read either the first, second or third reference mark. The tension on the web at the fourth control station is preferably about 10-14 lbs.

Although not shown, alternative embodiments of the present invention may comprise either fewer or more print control and print stations. Generally, one print control station and one print station are required for each shade or color of ink to be applied to each side of the web.

Station 327 is a dryer. The dryer 327 is preferably set at 2.2 Kw (about 50° C.). Station 329 is a chill roller which cools the web after passing through the dryer 327 . The chill roller 329 station preferably comprises a potentiometer and web tension adjustment means (not shown). The tension on the web at the chill roller 327 is preferably about 5 to 6 lbs., which is about 90% lower than the standard chill roller tension.

Station 330 is a slicer that divides the web 200 along a predetermined line, such as the printed centerline 213, thereby forming a true edge on each of the two halves of the original web. The slicer comprises a blade 332, the position of which is adjustable relative to the web (or the position of the web is adjustable relative to the blade). The slicer further comprises an optical sensor 334 that senses the position of the printing on the web by reading a control mark. The position of the blade (or the web) may be continuously monitored and adjusted to maintain the blade in register with the printing to ensure that the edge formed by the slicer is a true edge

Station 331 is a rewind station comprising means for spooling the two web halves.

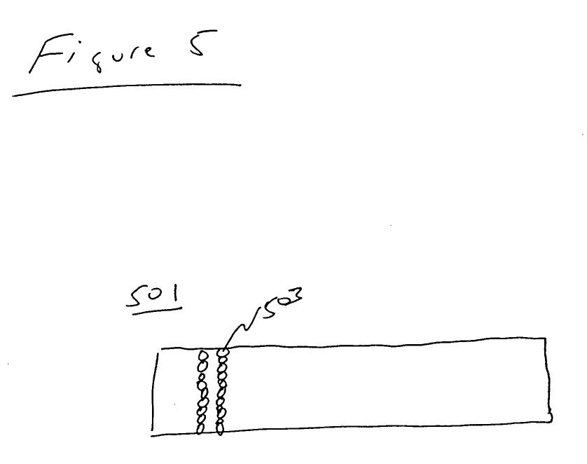

Print stations 311, 315, 321, and 325 each comprise a rotogravure print cylinder 312, 316, 322 and 326. Because the web material tends to elongate and narrow during the printing process, progressively larger print cylinders may be employed in the press 300 to help to maintain a carefully controlled tension on the web 200. Thus, each print cylinder is approximately 0.0002 of an inch larger than the previous print cylinder in the press 300. It will be understood by those skilled in the art that the exact sizes and changes of sizes of the cylinders will vary depending upon the specific web material as well as the press itself. Referring now to FIG. 5, there is shown a schematic view of a print cylinder 501 for use in the press 300. The cylinder 501 comprises cells 503 that may be relatively deeply etched to accommodate the fibrous nature of the material. In a preferred embodiment, the cells 503 on the cylinder 501 are about 195 microns wide, about 65-70 microns deep and carry an ink volume 1 1.76 cubic billion microns (cbm).

In a preferred embodiment, the rotogravure press 300 is a Fischer & Kracke rotogravure press set as follows: Unwind brakes on, set at 0; Festoons—3; Infeed—about 12; Coater #1—13 to 15; Chill—9800 on digital control, load cell shows about 5-10; Gears—80/80; Outfeed nip on, pressure 2 bar (vacuum off); Rewind pots at 90; LAM tension and outfeed tension vary with size of roll on rewind; Reference correction speeds at 7; AL at 0.5; Speed—105 to 115 ft./min.

### Cutting and Stacking System

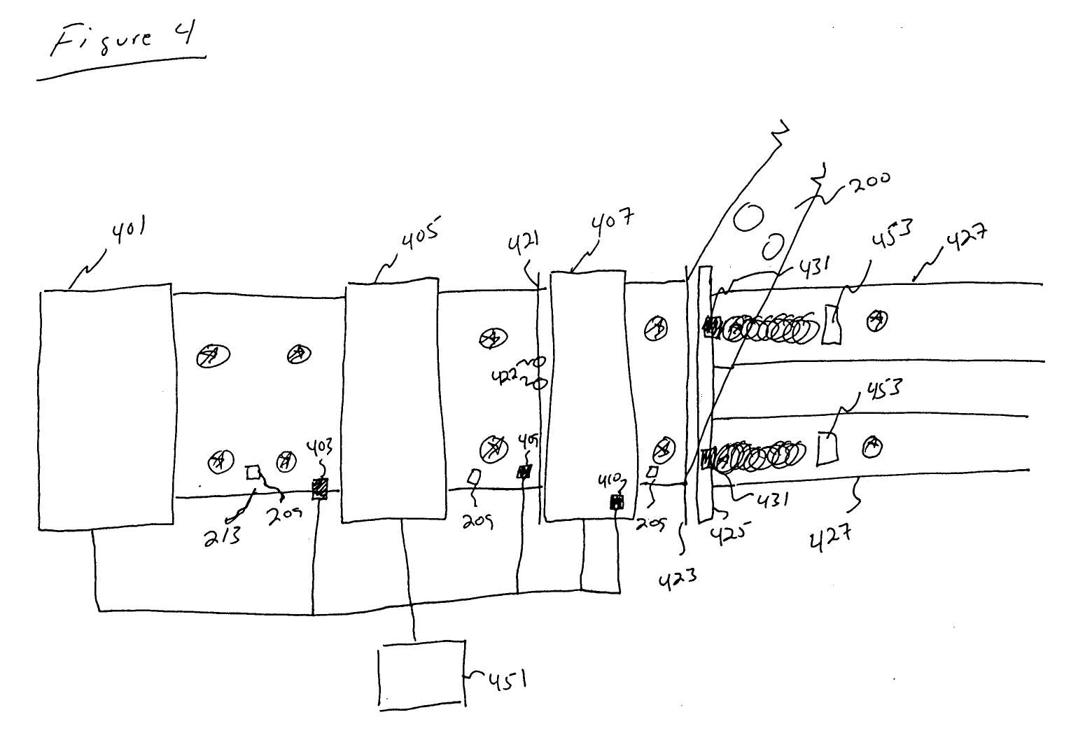

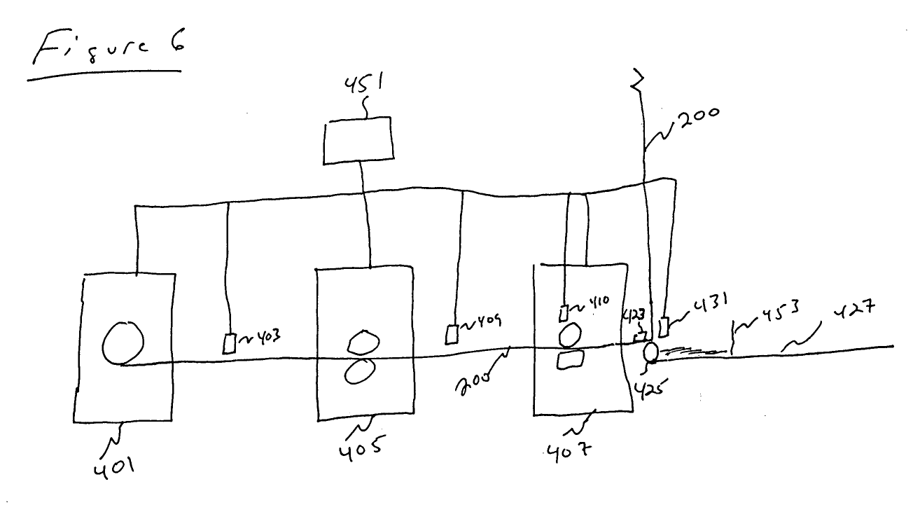

Referring now to FIGS. 4 and 6, there is shown a schematic diagram of a system 400 for cutting and stacking pads in accordance with the present invention from the printed web 200.

The unwind station 401 is preferably a braked rollstand. The unwind station has means to laterally adjust the position of the web 200. The lateral adjustment means may be a laterally adjustable roller, which laterally adjusts the position of the entire web roll, or an offset pivot guide, which adjusts the lateral position of the web after it is unwound from the roll. The lateral adjustment means are in communication with a lateral web position sensor 403. The lateral web position sensor senses the lateral position of the web 200 by sensing a suitable reference point, such as either the edge of the web or the printed center line 213. The sensor 403 controls the lateral adjustment means of the unwind station 401 to maintain the lateral position of the web, preferably to within about 0.25 mm to about 0.38 mm of the desired lateral position.

A driven infeed unit 405, preferably a nip roller, is positioned downstream of the unwind station 401. The infeed unit 405 pulls the web off of the roll on the unwind station 401 and feeds the web into the diecutter 407. An optical sensor 409 is preferably positioned downstream of the infeed unit and upstream of the diecutter 407.

In order to attain accurate cutting of the web, which has been irregularly stretched during the printing operation, several levels of error correction are preferably employed. The grossest level of error correction is accomplished by adjusting of the braking force on the unwind station 401. The intermediate level of error correction is accomplished by adjusting the speed of the infeed unit 405. The finest level of error correction is accomplished by adjusting the position of the diecutting cylinder 408.

In order for the error correction mechanisms to function, the repeat length of the printed designs on the web is intentionally made shorter than the repeat length of the diecutting cylinder 704. The difference between the repeat length on the diecutting cylinder and the repeat length on the web varies depending upon the elasticity of the web material. For the Dupont Sontara fabric, the repeat length on the diecutting cylinder is preferably about 0.5% greater than the repeat length on the web.

The error correction mechanisms are preferably controlled by a processor 451 that receives signals from the optical sensor 409, which reads a reference mark 209 printed on the web, and optical sensor 410, which reads a reference mark on the diecutting cylinder. The diecutter 407 preferably comprises a cylinder correction gearbox, preferably a 360 degree cylinder correction gearbox. The processor compares the position of the reference mark on the web to the position of the diecutting cylinder and adjusts the position of the diecutting cylinder to correct any detected error. The processor also counts the number of corrections in the same direction. When the count of consecutive corrections in the same direction exceeds a selected threshold, preferably about 4 corrections, the processor 451 adjusts the speed of the infeed unit 405. If the adjustments to the infeed unit speed exceed a predetermined threshold, preferably an amount equal to the difference between the repeat length on the web and the repeat length on the diecutting cylinder, the processor sends a signal to alert an operator to manually adjust the braking tension. Alternatively, the processor may electronically be coupled to the unwind station such that the processor can automatically control the braking tension. This combination of error correction means preferably enables the cutting system to operate at an accuracy of about +/−0.4 mm at steady running speeds.

Immediately before the web passes through the diecutter, the web passes through a static neutralizer 421, preferably an electronic or ionizer static neutralizer. Preferably, the static neutralizer comprises a pair of rigid electrodes 422 on a rigid bar 421 installed between about 0.5″ and 1.0″ from the web. There should be at least 6 mm of free air space above and beneath the web.

After passing through the diecutter 407, the material is routed through means for separating the printed pads from the web. A preferred separation means comprises a 90 degree turn-around a bar 423, preferably about ⅛ inch thick and about 1 inch wide, positioned above the web. The bar 423 works in connection with a small roller 425, preferably about 1 inch in diameter, positioned immediately after the bar 423 and beneath the web. The combination of the bar 423 and the roller 425 cause the printed pads that have been cut from the web to separate from the web and drop onto a driven conveyor 427 positioned beneath the small roller 425. The remaining web material is routed to a web removal rewind station.

The driven conveyor 427 is preferably comprises a separate conveyor for each column of printed designs. Since in a preferred embodiment of the present invention the designs are printed in rows of 4 columns across the web which is then divided in 2 parts before the cutting and stacking procedure, the driven conveyor 427 comprises pair of driven conveyors as shown in FIG. 4. The conveyors are independently driven slowly enough that the each printed pad drops onto the preceding pad and overlaps the preceding pad, preferably by about 90%, resulting in a shingled line of pads on the conveyor. A moveable gate 453, preferably a pneumatically operated gate, is positioned above each conveyor at a position downstream from where the pads drop onto the conveyor. The gate has a first lowered position in which it blocks the progress of the shingled row of pads along the conveyor and a second raised position in which it allows the shingled row of pads to proceed along the conveyor.

A pair of optical sensors 431, positioned above the roller 425 and just before the conveyors 427, sense each pad as it separates from the web and send a signal to a controller having an electronic counter. When the counter reaches a predetermined count for the conveyor, the controller signals the gate to move from the lowered position to the raised position and briefly increases the speed of the conveyor. As a result, stacks having the desired number of pads are advanced in discreet stacks along the conveyor where they may be manually packaged.

Those of ordinary skill in the art will recognize that many modifications and variations of the present invention may be implemented. The foregoing description and the following claims are intended to cover all such modifications and variations.

What is claimed is:

1. A pad for carrying liquid, comprising:
a piece of non-woven material wherein the piece of material is capable of absorbing an amount of the liquid at least about 1.5 times the weight of the piece of material;
a first printed ink on a first surface of the material;
a second printed ink on either the first or a second surface of the material;
wherein the first ink is substantially in register with the second ink.

2. The pad of claim 1, wherein the second printed ink is printed on the first surface and further comprising a printed ink on a second surface of the material and wherein the inks printed on the first and second surfaces are substantially in register.

3. The pad of claim 2, wherein the printed inks on the first and second surfaces of the material form first and second designs and the first and second designs are substantially the same.

4. The pad of claim 1, wherein the material has a thickness of about 30 mils to 50 mils.

5. The pad of claim 1, wherein the material is a non-woven polyester.

6. The pad of claim 5, wherein the material has a density of at least about 2.5 oz. per square yard.

7. The pad of claim 5, wherein the material has a density of about 4 oz. per square yard.

8. The pad of claim 1, wherein the material is a polyester cellulose blend.

9. The pad of claim 8, wherein the material is about 45% polyester and about 55% cellulose.

10. The pad of claim 1, wherein the designs are printed with ink that is approved by the United States Food and Drug Administration.

11. The pad of claim 10 herein the designs are printed with ink that is approved under California Proposition 65.

12. The pad of claim 11 wherein the designs are printed with ink that is compliant with CONEG.

13. The pad of claim 1, wherein the designs are printed with ink that is substantially non-leaching.

14. The pad of claim 13 wherein the ink is a non-carbon gravure ink.

15. The pad of claim 14 wherein the ink has a viscosity of about 17 to 30 seconds in a no. 2 zahn.

16. The pad of claim 1, wherein said piece of material is substantially circular.

17. The pad of claim 3:
wherein the design on the first surface is substantially the same as the design on the second surface;
the material has a thickness of about 30 mils to 50 mils;
the designs are printed with ink that is approved by the United States Food and Drug Administration;
the designs are printed with ink that is approved under California Proposition 65;
the designs are printed with ink that is compliant with CONEG;
the designs are printed with ink that is substantially non-leaching;
the ink is a non-carbon gravure ink;
the ink has a viscosity of about 17 to 30 seconds in a no. 2 zahn;
said piece of material is substantially circular.

18. The pad of claim 17, wherein material pad is a non-woven polyester having a density of about 4 oz. per square yard.

19. The pad of claim 17, wherein the material is about 45% polyester and about 55% cellulose.

20. A method for making a printed pad for carrying a liquid comprising the steps of:
feeding a web of non-woven material into a rotogravure press, wherein the material is
capable of absorbing at least about 1.5 times its own weight of the liquid;
printing a first ink with the press on a first surface of the web;
printing a second ink with the press substantially in register with the first ink on the first
surface or a second surface of the web.

21. The method of claim 20 wherein the second ink is printed on the first surface of the web and further comprising the step of printing an ink on the second surface of the web.

22. The method of claim 21 wherein the first and second designs are the same.

23. The method of claim 21, wherein the material is a non-woven polyester.

24. The method of claim 21, wherein the material is a polyester cellulose blend.

25. The method of claim 21, wherein the press comprises means for maintaining tension on the web and the means for maintaining tension on the web are set at the lowest tension sufficient to prevent the web from binding in the press.

26. The method of claim 24, wherein the web is fed into the press at about 105 to 115 feet per minute.

27. The method of claim 21, wherein the press comprises a first control station and the tension on the web at the first control station is about 15 lbs.

28. The method of claim 27, wherein the press comprises a second control station and the tension on the web at the second control station is about 12-14 lbs.

29. The method of claim 28, wherein the press comprises a third control station and the tension on the web at the third control station is about 12-14 lbs.

30. The method of claim 29, wherein the press comprises a fourth control station and the tension on the web at the fourth control station is about 12-14 lbs.

31. The method of claim 21, wherein the press comprises a dryer and the dryer is set at about 50° C.

32. The method of claim 21, wherein the press comprises a chill roller and the tension on the web at the chill roller is about 5-6 lbs.

33. The method of claim 21, wherein the press comprises a plurality of print cylinders in series and each print cylinder is about 0.0002 inches larger in diameter than the preceding print cylinder.

34. The method of claim 21, wherein the press comprises a print cylinder and the cylinder comprises a plurality of cells and each cell is about 195 microns wide, about 65 to 70 microns deep and carries an ink volume of about 1.76 cbm.

35. A system for cutting printed designs from a web of elastic material to form printed pads wherein the printed designs are printed on the web at a repeat length comprising:
(a) a braked unwind station having a variable braking tension;
(b) an infeed station having an adjustable speed;
(c) a diecutter comprising a diecutting cylinder and a cylinder correction gearbox capable of correcting the position of the diecutting cylinder in a positive or negative rotational direction, wherein the circumference of the diecutting cylinder is greater than the repeat length.
(d) a first sensor for sensing the position of the printed designs on the web;
(e) a second sensor for sensing the position of the diecutting cylinder;
(f) a processor electronically coupled to the first sensor, the second sensor, the infeed station and the diecutter for controlling the infeed station and the diecutter in response to signals received from the sensors,
wherein the processor sends a correction signal to the diecutting cylinder in response to signals from the sensors, the processor comprises a first counter for counting the number of consecutive corrections of the diecutting cylinder in the same direction and sending a correction signal to the infeed station when a predetermined number of consecutive corrections of the diecutting cylinder is reached.

36. The system of claim 35, wherein the processor sends a correction signal to the infeed station after 4 consecutive corrections of the diecutting cylinder.

37. The system of claim 35, wherein the printed designs on the web have a repeat length and the diecutting cylinder has a repeat length about 0.5% greater than the repeat length than the repeat length of the designs on the web.

38. The system of claim 35 further comprising means for separating the printed pads from the web material after the web has passed through the die cutter.

39. The system of claim 35 further comprising means for neutralizing the static charge of the web.

40. The system of claim 35 further comprising:
(a) a conveyor, having a variable speed motor controlled by the processor, for receiving the printed pad after the printed pad is separated from the web;
(b) a sensor electronically coupled to the processor for sending a signal to the processor each time a printed pads is received on the conveyor;
wherein the processor comprises a second counter for counting the number of pads received on the conveyor and when a predetermined number of pads is received on the conveyor the processor sends a signal to the conveyor motor to temporarily increase the speed of the conveyor.

41. The system of claim 40 further comprising a gate having a first position immediately above the conveyor in which the gate impedes the progress of the printed pads on the conveyor and a second position above the first position in which the gate does not impede the progress of the printed pads on the conveyor, wherein the gate is electronically coupled to the processor and the processor sends a signal to raise the gate at the same time the processor sends a signal to increase the speed of the conveyor.

42. The system of claim 34, wherein the processor sends a signal to an operator to adjust the braking tension on the unwind station when the corrections to the infeed station exceed a predetermined threshold.

43. A pad comprising:
a piece of non-woven material wherein the material is a non-woven polyester or a polyester-cellulose blend; and
a first printed ink on a first surface of the material wherein said piece of non-woven material is formed from a web of said non-woven material which piece is formed with substantially the same dimensions and shape as other pieces of non-woven material formed from the same web.

44. The pad of claim 43 further comprising a second printed ink on either the first or a second surface of the material; wherein the first ink is substantially in register with the second ink.

45. The pad of claim 43, wherein the second printed ink is printed on the first surface and further comprising a printed ink on a second surface of the material and wherein the inks printed on the first and second surfaces are substantially in register.

46. The pad of claim 45, wherein the printed inks on the first and second surfaces of the material form first and second designs and the first and second designs are substantially the same.

47. The pad of claim 43, wherein the material has a thickness of about 30 mils to 50 mils.

48. The pad of claim 43, wherein the material has a density of at least about 2.5 oz. per square yard.

49. The pad of claim 43, wherein the material has a density of about 4 oz. per square yard.

50. The pad of claim 43, wherein the material is about 45% polyester and about 55% cellulose.

51. The pad of claim 43, wherein the designs are printed with ink that is approved by the United States Food and Drug Administration.

52. The pad of claim 51 wherein the designs are printed with ink that is approved under California Proposition 65.

53. The pad of claim 52 wherein the designs are printed with ink that is compliant with CONEG.

54. The pad of claim 43, wherein the designs are printed with ink that is substantially non-leaching.

55. The pad of claim 54 wherein the ink is a non-carbon gravure ink.

56. The pad of claim 55 wherein the ink has a viscosity of about 17 to 30 seconds in a no. 2 zahn.

57. The pad of claim 43, wherein said shape is substantially circular.

58. A pad comprising:
a piece of non-woven material wherein the material comprises either a polyester or a polyester cellulose blend; and
a first ink printed on a first surface of the piece of non-woven material, wherein the ink is substantially non-leaching.

59. A pad comprising:
a piece of non-woven material wherein the material comprises either a polyester or a polyester cellulose blend; and
a first ink printed on a first surface of the piece of non-woven material, wherein the ink forms
a design and wherein the ink does not substantially diffuse in the piece of non-woven material to cause significant distortion of the design.
